(19) United States
(12) Patent Application Publication
(10) Pub. No.: US 2008/0267846 A1
(43) Pub. Date: Oct. 30, 2008

(54) PROCESSES FOR THE PURIFICATION AND OXIDATION OF A HYDROGEN CHLORIDE-CONTAINING GAS WHICH ALSO CONTAINS SULFUR COMPOUND(S)

(75) Inventors: Michel Haas, Dormagen (DE); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/110,722

(22) Filed: Apr. 28, 2008

(30) Foreign Application Priority Data
Apr. 26, 2007 (DE) 102007020146.1

(51) Int. Cl. B01D 53/48; B01D 53/68

(52) U.S. Cl. 423/240 R; 423/242.1; 423/244.09; 423/243.02; 423/243.1

(57) ABSTRACT

Processes comprising: providing a crude gas comprising hydrogen chloride and at least one sulfur compound; and passing the crude gas across a sacrificial material such that at least a portion of the at least one sulfur compound is oxidized and precipitated as sulfate onto the sacrificial material to provide a hydrogen chloride product gas.

### BACKGROUND OF THE INVENTION

A large number of chemical processes for reaction with chlorine or phosgene, such as the production of isocyanates or chlorination reactions of aromatics, can lead to the inevitable generation of hydrogen chloride. As a general rule this hydrogen chloride is converted back into chlorine by electrolysis (cf. e.g. WO 97 24320 A1). In contrast to this very energy-intensive method, the thermal oxidation of hydrogen chloride with pure oxygen or with an oxygen-containing gas on heterogeneous catalysts (known as the Deacon process) as follows

4HCl+O₂ [symbol] 2Cl₂+2H₂O

offers clear advantages in terms of energy consumption (see erg. WO 040 14 845).

The catalytic oxidation of HCl gas with O₂ to form Cl₂ and H₂O is typically performed on heterogeneous catalysts. The most diverse catalysts are used, based for example on ruthenium, chromium, copper, etc., supported or unsupported. Such catalysts are described for example in JP 2001 019405, DE 1 567 788 A1, EP 251 731 A2, EP 936 184 A2, EP 761 593 A1, EP 711 599 A1 and DE 105 50 131 A1. In particular, components based on metallic ruthenium, ruthenium oxide, ruthenium mixed oxide (mixed ruthenium oxide), ruthenium oxychloride and ruthenium chloride, supported or unsupported, can be used here. Suitable supports in this connection are, for example, tin oxide, aluminum oxide, silicon oxide, aluminum-silicon mixed oxides, zeolites, oxides and mixed oxides (e.g. of titanium, zirconium, vanadium, aluminum, silicon, etc.), metal sulfates and clay. The choice of possible supports is not restricted to this list, however.

Sulfur components in particular, such as for example H₂SO₄ and other sulfur compounds, have been identified as catalyst poisons. SO₂, SO₃, COS, H₂S, etc., are also potential catalyst poisons and can deposit on the Deacon catalyst. These sulfur components usually accumulate initially on the front part of the catalyst bed and then slowly settle across the entire catalyst bed over time. The catalytic activity is reduced as a consequence, which is not acceptable for industrial use. A further cause of loss of activity is the fact that most Deacon catalysts are thiophilic and thus form more or less stable compounds with the sulfur compounds even under very acid conditions, thereby rendering the catalytically active component inaccessible or deactivating it. For optimal running of the Deacon process it is therefore necessary to have as low as possible a content of sulfur components in the HCl gas.

However, in process steps for polyisocyanate production, such as phosgenation, considerable amounts of sulfur components and in some cases also organic compounds, carbon monoxide (CO) and other compounds can be contained as impurities in the HCl gas and introduced into the Deacon process. The sulfur components can originate in the intermediate products natural gas or coal which are used to produce phosgene. Further sulfur sources can be present in the overall production process, for example, and can contaminate the HCl gas stream. Since even small amounts of sulfur can cause reversible or irreversible damage to the commonly used catalysts and can thus give rise to an extended production stoppage and lead to a costly catalyst replacement, extensive and laborious purification of the educts for a downstream Deacon process is preferable in this case. This purification of the educts before they enter the Deacon reactor is therefore essential to the operating life of the catalyst. This purification can be applied both to the incoming stream of crude HCl gas, from isocyanate production for example, and to a possible recycled gas stream containing HCl. The catalytic HCl oxidation is thermodynamically limited, and a preferred embodiment of the Deacon process involves recycling the unreacted hydrogen chloride, the gas stream conventionally being dried over sulfuric acid. This recycled gas stream can be contaminated with sulfur compounds such as e.g. H₂SO₄, SO₂ and SO₃.

The use of a pre-reactor to remove CO from HCl gas by oxidation is known from the prior art (EP 233 773 A1). The background to this is the extension of the life of the actual Deacon catalyst (chromium oxide) by reducing the CO content in the HCl gas. This publication does not provide the removal of catalyst poisons such as sulfur components.

EP 0 478 744 A1 describes the removal of SO₂ from burner gases by adsorption. A catalytic oxidation process is not described here either. In particular, purification of an HCl stream by removal of sulfur components for use in a Deacon process is not described here.

The publication JP 2005-177614 describes the removal of sulfur components from gas containing HCl or Cl₂. The removal occurs through contact between these gases and metals or compounds thereof. The metals are chosen from groups VIII to X of the periodic table. The protection of catalysts is not provided by this publication. A simultaneous oxidation of CO and other oxidizable secondary components is likewise not described.

The other conceivable technical alternative to purification of the HCl gas by scrubbing with water is not acceptable because the HCl would be absorbed and the liquid hydrochloric acid would have to be processed and freed from water.

### BRIEF SUMMARY OF THE INVENTION

The present invention relates, in general, to processes for purifying a hydrogen chloride-containing crude gas to remove sulfur compounds by oxidation with oxygen. The invention also concerns a process for producing chlorine from a hydrogen chloride-containing gas containing additional secondary components such as sulfur compounds, carbon monoxide and hydrocarbons along with further oxidizable constituents, which process includes the step of catalytic removal of the secondary components in an upstream process under isothermal or adiabatic conditions.

The solution to the technical problem as proposed in the present invention is to perform the purification of the HCl gas via a chemical reaction in a pre-reactor containing a catalyst onto which the poisons for the actual Deacon catalyst are deposited.

The invention provides a process for purifying a hydrogen chloride-containing crude gas to remove sulfur compounds by oxidation with oxygen and passage of the gases across a sacrificial material, in particular a sacrificial catalyst, particularly preferably an oxidation catalyst, characterised in that the sulfur compounds oxidised with oxygen are deposited onto the sacrificial material as sulfate in particular.

One embodiment of the present invention includes processes comprising: providing a crude gas comprising hydrogen chloride and at least one sulfur compound; and passing the crude gas across a sacrificial material such that at least a portion of the at least one sulfur compound is oxidized and deposited as sulfate onto the sacrificial material to provide a hydrogen chloride product gas.

Particularly suitable for use as a sacrificial material in various embodiments of the processes according to the present invention are oxidation catalysts which catalyze and start the reaction of the sulfur compounds to form SO₂ and then SO₄²⁻, for example, and catalysts which contain a particularly thiophilic component. In particular, elements from groups VIII, IX and X of the periodic table can be used. Ruthenium, palladium, platinum, chromium, copper, rhodium, iridium, gold, iron, manganese, cobalt, zirconium and bismuth compounds can particularly preferably be used, along with other thiophilic and/or oxidising catalysts. These elements can be used alone or in combination and in particular can take the form of their oxides.

Particularly preferably suitable are components based on metallic ruthenium, ruthenium oxide, ruthenium mixed oxide, ruthenium oxychloride and ruthenium chloride, which can be used here in supported or unsupported form, preferably supported.

Suitable supports for sacrificial catalysts in this connection are for example tin oxide, aluminum oxide, silicon oxide, aluminum-silicon mixed oxides, zeolites, oxides and mixed oxides (e.g. of titanium, zirconium, vanadium, aluminum, silicon, etc.), metal sulfates and clay. The choice of possible supports is not limited to this list, however. Particularly, thiophilic supports can also have a synergistic effect on sulfur precipitation.

It has been found that the presence of oxygen facilitates the deposition of the sulfur components, A preferred addition of chlorine gas can farther accelerate this process. The additional presence of water can also have a positive effect on sulfur precipitation. The oxidation and precipitation of the sulfur compounds is therefore preferably performed in the presence of chlorine gas and/or water.

Combining the precipitation of sulfur components with the oxidation of CO, organic components and other oxidizable constituents, adiabatically or isothermally, which may likewise be contained in the HCl gas, is particularly advantageous: since the oxidation of CO to CO₂ is significantly more exothermic than the oxidation of HCl, hot spots can occur in the Deacon reactor if CO is present in the HCl gas, damaging the Deacon catalyst. Irreversible damage to the catalyst due to sintering processes is also conceivable. A reversible or irreversible formation of metal carbonyls can also occur, which is in direct competition to HCl oxidation. A further disadvantage of the presence of CO in the HCl gas could arise from the volatility of these metal carbonyls, as a result of which not inconsiderable amounts of catalytically active component can be lost.

Another advantage of the processes according to the present invention includes the additional removal of carbon monoxide from the HCl gas.

### BRIEF DESCRIPTION OF THE SEVERAL VIEWS OF THE DRAWING

The foregoing summary, as well as the following detailed description of the invention, may be better understood when read in conjunction with the appended drawing. For the purpose of assisting in the explanation of the invention, there is shown in the drawing a representative embodiment which is considered illustrative. It should be understood, however, that the invention is not limited in any manner to the precise arrangements and instrumentalities shown.

In the drawing:

FIG. 1 is a flow diagram of a process according to one embodiment of the invention.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a gas” herein or in the appended claims can refer to a single gas or more than one gas. Additionally, all numerical values, unless otherwise specifically noted, are understood to be modified by the word “about.”

In various particularly preferred embodiments of the present invention, the HCl-containing crude gas also contains CO, which is oxidized by the added oxygen to form CO₂, the sacrificial material acting in particular as a catalyst.

In order to ensure a complete oxidation of CO, e.g. in a pre-reactor, O₂ must be added in excess. The excess O₂ can then additionally be used for the oxidation of sulfur components, which are generally contained in the HCl gas in the ppm range.

However, in most processes such as isocyanate production, considerable amounts of hydrocarbons can be contained as impurities in the HCl waste gas and introduced into the Deacon process. The hydrocarbons can originate from the production of the isocyanates, in which solvents such as orthodichlorobenzene and monochlorobenzene are used. Since even the smallest amounts of hydrocarbons during HCl oxidation can become highly toxic compounds such as dioxins, purification of the gases is absolutely essential.

In addition, while the process is running, hydrocarbons can form coke deposits on the catalyst. These deposits can cause reversible or irreversible damage to the catalyst. This additionally requires purification of the educt gases. This purification of the educts before they enter the Deacon reactor is therefore essential to the operating life of the catalyst.

Thus, yet another advantage of the processes according to the present invention is therefore the additional removal of any hydrocarbons present in the crude HCl gas.

A significantly easier and also more efficient and reliable method is to avoid the formation of these chlorinated derivatives by reducing the content of hydrocarbons prior to the actual hydrogen chloride oxidation stage by oxidation of these hydrocarbons.

The processes according to the invention thus particularly preferably provide a process combined with sulfur removal in which the HCl-containing crude gas additionally contains further oxidizable carbon compounds which are oxidized with oxygen to form CO₂.

A further advantage is offered if the CO oxidation is performed adiabatically, since then the HCl gas is simultaneously preheated for the Deacon reaction. In the Deacon or Deacon-like processes described, if the HCl oxidation is to be performed efficiently, the HCl stream or HCl-containing gas has to be preheated from the initial temperature in the range from around −10 to 60° C. to a temperature in the range from 150 to 350° C. by the input of energy from outside, e.g. via heat exchangers ahead of the entrance to the reaction. This increases the energy costs and investment costs for an industrial plant.

In particular, the combination of sulfur removal and CO oxidation and the oxidation of additional constituents can be performed adiabatically or isothermally on the aforementioned catalyst systems.

An additional advantage of the adiabatic mode of operation is the use of the temperature rise due to CO oxidation as a measure for the activity of the catalyst and hence the progress of the poisoning in the pre-reactor. To this end the pre-reactor must be designed in such a way that if a fresh, unpoisoned catalyst is used in it, the reaction of CO is complete. By measuring the CO content at the entrance to and optionally at the exit from the pre-reactor, the temperature rise with complete reaction of the CO can be calculated. If the actual temperature rise is lower than the calculated rise, the activity of the catalyst has been reduced by poisoning. By means of suitable experiments it is possible to determine in advance the degree of poisoning above which the entrainment of sulfur components is likely. This simple measurement step avoids the need for an elaborate sulfur analysis in the trace range, and this constitutes a particular economic advantage.

The reduction in the activity of the sacrificial catalyst can also be determined in the isothermal mode of operation by measuring the CO content before and after the sacrificial catalyst. If CO is still found after the reactor, the activity due to poisoning can be demonstrated in this way. In this case too, experiments are needed to determine in advance the degree of poisoning above which the entrainment of sulfur components is likely.

The invention can be performed in both a fixed bed reactor and a fluidized bed reactor.

The various embodiments of the present invention can provide highly efficient processes for separating sulfur components from the HCl-containing gas, which can then be supplied, in particular, to a Deacon or Deacon-like process for oxidation of the hydrogen chloride with oxygen. Such processes can optionally be combined with an oxidation of carbon monoxide (CO) and other oxidizable components. The latter option can also lead to a simplified monitoring of the progress of the poisoning by allowing the oxidation activity to be checked.

The present invention thus also concerns a process for the catalytic oxidation of hydrogen chloride with oxygen, which is characterized in that the aforementioned process for the removal of sulfur compounds and optionally simultaneous oxidation of CO and of hydrocarbons in the crude HCl gas takes place ahead of the catalytic oxidation of hydrogen chloride and the resulting hydrogen chloride freed from sulfur compounds is used.

Various preferred embodiments of processes according to the invention for producing chlorine from a hydrogen chloride-containing gas include the following:
a) removal of sulfur components and optionally a simultaneous catalytic oxidation of CO and other oxidizable components with oxygen in an upstream reactor in accordance with the aforementioned aspects of the invention; and
b) catalytic oxidation of the hydrogen chloride in the hydrogen chloride-containing gas resulting from step a) with oxygen to form chlorine.

The gas containing hydrogen chloride and sulfur and also carbon monoxide which is used in such preferred processes can be the waste gas from a phosgenation reaction to form organic isocyanates. However, it can also be the waste gas from hydrocarbon chlorination reactions.

The crude hydrogen chloride gas containing sulfur compounds and optionally CO for reaction according to the invention can contain further oxidizable constituents such as in particular hydrocarbons.

The content of hydrogen chloride in the crude gas which is to be purified, containing hydrogen chloride and sulfur compounds, is in particular from 20 to 99.5 vol. %.

The content of sulfur compounds in the crude gas containing hydrogen chloride and sulfur compounds which enters the pre-reactor in step a) is in particular at most 1 vol. % As a result of a sulfur-removal process according to the invention, in combination with an isocyanate process for example, considerably higher amounts of sulfur compounds can be tolerated in the waste gas from the phosgenation process.

The precipitation of the sulfur components and optionally the oxidation of CO and further oxidizable constituents in step a) is conveniently performed by adding oxygen, oxygen-enriched air or air. The addition of oxygen or oxygen-containing gas can take place stoichiometrically, relative to the amount of sulfur and optionally carbon monoxide/additional oxidizable constituents, or be performed with an oxygen excess. Through the adjustment of the oxygen excess and optionally an optional addition of inert gases, preferably nitrogen, the dissipation of heat from the catalyst in step a) and the exit temperature of the process gases can optionally be controlled.

The intake temperature of the crude gas containing hydrogen chloride and sulfur compounds in step a) is preferably 0 to 400° C., by preference 100 to 350° C.

Depending on the amount of heat released in the CO oxidation in step a), the exit temperature of the hydrogen chloride-containing gas is in particular 100 to 600° C., preferably 100 to 400° C.

In preferred processes, the deposition of sulfur components in the presence of carbon monoxide can be performed adiabatically and the reaction heat that is released can thus also be used to heat the feed materials (crude HCl gas) in order to be sent on for HCl oxidation in the next step.

In the combined process step a) is preferably performed under pressure conditions corresponding to the operating pressure of the HCl oxidation process in step b). The operating pressure is generally 1 to 100 bar, preferably 1 to 50 bar, particularly preferably 1 to 25 bar. To compensate for the pressure drop in the bed of sacrificial material, a slightly elevated pressure relative to the exit pressure is preferably used.

The gas emerging from the purification process a) contains in particular substantially HCl, CO₂, O₂ and optionally further secondary constituents such as nitrogen or inert gases. The unreacted oxygen can subsequently be used for the downstream HCl oxidation in step b).

The low-sulfiur gas emerging from the purification process a) is optionally passed through a heat exchanger to the reactor for oxidation of the hydrogen chloride in step b). The heat exchanger between the reactor for step b) and the pre-reactor for step a) is conveniently coupled to the pre-reactor for step a) via a temperature control. The heat exchanger allows the temperature of the gas which is subsequently transferred to the HCl oxidation step to be precisely adjusted. Heat can be added if necessary if the exit temperature is too low. If the exit temperature is too high, heat can be removed, by the generation of steam for example.

If the purification process according to the invention is coupled to the HCl oxidation, the oxidation of hydrogen chloride with oxygen to form chlorine is performed in a manner known per se.

Thus in the Deacon process in step b), hydrogen chloride is oxidised with oxygen in an exothermic equilibrium reaction to form chlorine, with production of steam. The reaction temperature is conventionally 150 to 500° C., the conventional reaction pressure is 1 to 25 bar. Since the reaction is an equilibrium reaction, it is convenient to operate at the lowest possible temperatures at which the catalyst is still sufficiently active. It is also convenient to use oxygen in hyperstoichiometric amounts relative to the hydrogen chloride. A two to four times oxygen excess is conventional for example. Since there is no risk of selectivity losses, it can be economically advantageous to operate at relatively high pressure and correspondingly with a longer residence time in comparison to operation at normal pressure.

Suitable preferred catalysts for the Deacon process contain ruthenium oxide, ruthenium chloride or other ruthenium compounds on silicon dioxide, aluminum oxide, titanium dioxide or zirconium dioxide as the support. Suitable catalysts can be obtained for example by applying ruthenium chloride to the support followed by drying or drying and calcining. Suitable catalysts can also contain, in addition to or in place of a ruthenium compound, compounds of other noble metals, for example gold, palladium, platinum, osmium, iridium, silver, copper or rhenium. Suitable catalysts can additionally contain chromium oxide or bismuth compounds.

The catalytic hydrogen chloride oxidation can be performed adiabatically or isothermally or virtually isothermally, discontinuously but preferably continuously, as a fluidised bed or fixed bed process, preferably as a fixed bed process, particularly preferably in multitube flow reactors on heterogeneous catalysts at a reactor temperature of 180 to 500° C., preferably 200 to 400° C., particularly preferably 220 to 450° C., and a pressure of 1 to 25 bar (1000 to 25000 hPa), preferably 1.2 to 20 bar, particularly preferably 1.5 to 17 bar and in particular 2.0 to 15 bar.

Conventional reactors in which the catalytic hydrogen chloride oxidation is performed are fixed bed or fluidised bed reactors. The catalytic hydrogen chloride oxidation can also be performed as a multistage process.

In the isothermal or virtually isothermal and adiabatic mode of operation, multiple—i.e. 2 to 10, preferably 2 to 6, particularly preferably 2 to 5, in particular 2 to 3-reactors connected in series with additional intercooling can also be used. The hydrogen chloride can either be added in full together with the oxygen ahead of the first reactor or be divided between the various reactors. This series of individual reactors can also be combined to form a single unit

A further preferred embodiment of a suitable device for the process involves the use of a structured catalyst bed in which the catalyst activity rises in the direction of flow. Such a structuring of the catalyst bed can be achieved by means of differing impregnation of the catalyst support with active substance or by differing dilution of the catalyst with an inert material. Rings, cylinders or spheres for example of titanium dioxide, zirconium dioxide or mixtures thereof, aluminum oxide, steatite, ceramics, glass, graphite, stainless steel or nickel alloys can be used as the inert material. With the preferred use of catalyst mouldings the inert material should preferably have similar external dimensions.

Mouldings of any shape are suitable as catalyst mouldings; tablets, rings, cylinders, stars, cartwheels or spheres are preferred, with rings, cylinders or star-shaped extrudates being the particularly preferred shape.

Particularly suitable as heterogeneous catalysts are supported ruthenium compounds or copper compounds which can optionally also be doped, optionally doped ruthenium catalysts being preferred. Suitable support materials include for example silicon dioxide, graphite, titanium dioxide with rutile or anatase structure, zirconium dioxide, aluminum oxide or mixtures thereof, preferably titanium dioxide, zirconium dioxide, aluminum oxide or mixtures thereof, particularly preferably γ- or δ-aluminum oxide or mixtures thereof.

The copper or ruthenium supported catalysts can be obtained for example by impregnating the support material with aqueous solutions of CuCl₂ or RuCl₃ and optionally a doping promoter, preferably in the form of chlorides thereof Moulding of the catalyst can take place after or preferably before impregnation of the support material.

Suitable promoters for doping the catalysts are alkali metals such as lithium, sodium, potassium, rubidium and caesium, preferably lithium, sodium and potassium, particularly preferably potassium, alkaline-earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The mouldings can then be dried at a temperature of 100 to 400° C., preferably 100 to 300° C., for example under a nitrogen, argon or air atmosphere, and optionally calcined. The mouldings are preferably first dried at 100 to 150° C. and then calcined at 200 to 400° C.

The conversion of hydrogen chlorine in a single pass can preferably be limited to 15 to 90%, preferably 40 to 85%. After being separated off, some or all of the unreacted hydrogen chlorine can be returned to the catalytic hydrogen chloride oxidation stage.

The heat of reaction from the catalytic hydrogen chloride oxidation can advantageously be used to generate high-pressure steam. This can be used to operate a phosgenation reactor or distillation columns, for example, in particular isocyanate distillation columns.

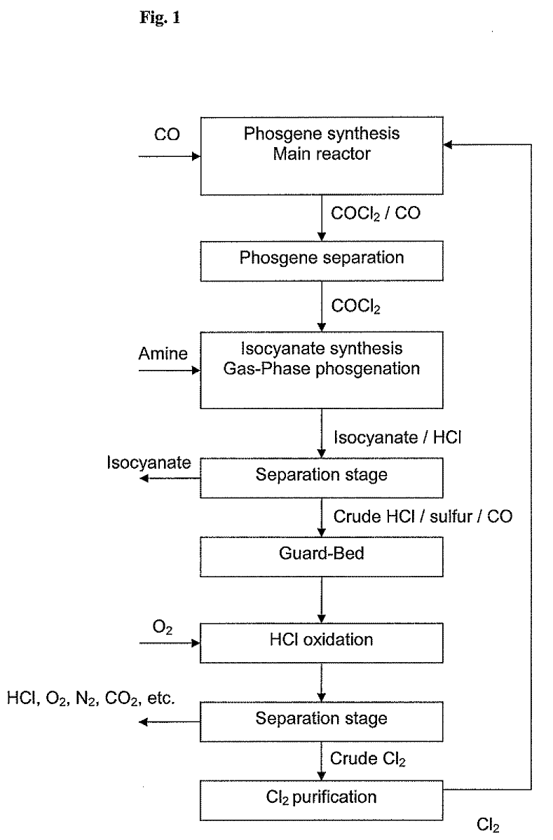

The chlorine obtained by the process according to the invention can then be reacted with carbon monoxide by the process known from the prior art to form phosgene, which can be used to produce TDI or MDI from TDA or MDA. The hydrogen chloride which is formed in turn in the phosgenation of TDA and MDA can then be converted to chlorine by the process described. FIG. 1 illustrates the process according to the invention as integrated into the synthesis of isocyanate.

Through the process according to the invention the sulfur content in the HCl stream is significantly reduced, as a result of which a deactivation of the Deacon catalyst in the next stage is slowed down.

The invention will now be described in further detail with reference to the following non-limiting example.

### EXAMPLE

Referring to FIG. 1, depicted is a process flow for a combination of a purification process according to an embodiment of the invention and an upstream isocyanate production process.

In a first step phosgene is produced from carbon monoxide in the phosgene synthesis; the phosgene is then separated off and purified.

A toluene diamine is then reacted in the gas phase with the purified phosgene to form toluene diisocyanate and hydrogen chloride, and in a next separation stage the toluene diisocyanate is separated from the crude hydrogen chloride gas.

The hydrogen chloride gas, which in addition to sulfur components also contains residual carbon monoxide, is passed across a sacrificial bed of ruthenium chloride catalyst in which with addition of oxygen the sulfur compounds are reacted to form SO₄²⁻ and carbon monoxide is reacted to form carbon dioxide.

In a downstream Deacon reaction the purified HCl gas is oxidised in an oxygen excess on a calcined ruthenium chloride catalyst supported on tin oxide to form chlorine. The by-products and unreacted gases—hydrogen chloride, oxygen, nitrogen and carbon dioxide—are separated off and the chlorine obtained is isolated and recovered. The recovered chlorine is then returned to the phosgene production stage.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising: providing a crude gas comprising hydrogen chloride and at least one sulfur compound; and passing the crude gas across a sacrificial material such that at least a portion of the at least one sulfiur compound is oxidized and precipitated as sulfate onto the sacrificial material to provide a hydrogen chloride product gas.

2. The process according to claim 1, wherein the sacrificial material comprises an oxidation catalyst.

3. The process according to claim 1, wherein the sacrificial material comprises a catalyst for the oxidation of a sulfur compound.

4. The process according to claim 1, wherein the oxidation and precipitation of the at least one sulfur compound is carried out in the presence of chlorine gas.

5. The process according to claim 1, wherein the oxidation and precipitation of the at least one sulfur compound is carried out in the presence of water.

6. The process according to claim 4, wherein the oxidation and precipitation of the at least one sulfur compound is carried out in the presence of water.

7. The process according to claim 1, wherein the crude gas further comprises CO, and at least a portion of the CO is oxidised to form CO₂.

8. The process according to claim 1, wherein the crude gas further comprises one or more additional oxidizable carbon compounds which are oxidized to form CO₂.

9. The process according to claim 1, wherein the oxidation is carried out adiabatically and at least a portion of the heat of reaction is used to preheat the crude gas.

10. The process according to claim 7, further comprising comparing measured and calculated conversion of CO to provide a determination of the contamination of the sacrificial material.

11. The process according to claim 7, further comprising comparing the measured and calculated temperature rise of the gas passed over the sacrificial material to provide a determination of the relative contamination of the sacrificial material.

12. The process according to claim 1, wherein the crude gas comprises a product gas derived from a production process for the production of polyisocyanates or from the chlorination of an aromatic compound.

13. The process according to claim 1, further comprising feeding the hydrogen chloride product gas to a subsequent catalytic oxidation reaction of the hydrogen chloride.
